(19) United States
(12) Patent Application Publication
(10) Pub. No.: US 2009/0062699 A1
(43) Pub. Date: Mar. 5, 2009

(54) DEVICE FOR REGULATING BLADDER MERIDIAN AND CHANNEL SINEWS OF FOOT TAIYANG

(76) Inventor: Shang Chieh YANG, Tainan (TW)

Correspondence Address: Dr. BANGER SHIA;Int''l Patent Office of Bang Shia, 102 Lindencrest Ct, Sugar Land, TX, 77479-5201, US

(21) Appl. No.: 11/846,517

(22) Filed: Aug. 28, 2007

(51) Int. Cl. A61H 1/00

(52) U.S. Cl. 601/23

(57) ABSTRACT

A device for regulating Bladder Meridian and Channel Sinews of Foot Taiyang includes a board having a top face and a bottom face. A rib is formed on an end of the top face. A plurality of holes are defined in the bottom faces and have different distances to the rib. A leg is removably engaged with one of the holes of the bottom face of the board to support the board in one of a plurality of inclination angles. In use, a user stands on the top face of the board, with his or her heels abutting against and supported by the rib. The feet of the user rest on the top face of the board and are, thus, in a bent position toward the lower limbs of the user to stretch the posterior sinews of the lower limbs of the user.

### BACKGROUND OF THE INVENTION

The present invention relates to a device for regulating Bladder Meridian and Channel Sinews of Foot Taiyang of a user's by stretching the posterior sinews of the lower limbs of the user.

According to traditional Chinese medicine, the meridians (or channels or pathways in the human body) and acupoints of a human body are closely associated with the internal organs whose functions can be activated through stimulation of the associated meridians and acupoints by massage, acupuncture, or particular movements or postures.

Among the twelve meridians of the human body, Bladder Meridian of Foot Taiyang is regarded by ancient medical practitioners as a meridian of vital importance, for being conducive to bodybuilding and coordination of the internal organs of the body. Bladder Meridian of Foot Taiyang starts at the upper inner corners of the eyes, passes the brows, reaches the top of the head, goes down while flanking Du Meridian and along the muscles near the spine, passes the rear of the thighs and legs, and terminates at the outer corner of the little toes. The longest meridian of the body, Bladder Meridian of Foot Taiyang is bilaterally symmetrical and has a total of 134 acupoints.

It is generally believed in traditional Chinese medicine that stimulating the Bladder Meridian of Foot Taiyang will have effects on several body parts including the eyes, nose, head, neck, waist, and back to relieve many symptoms including headache, palpitation, perturbation, absent-mindedness, neurasthenia, insomnia, neck stiffness, aches in shoulder, waist, and back, enuresis, spermatorrhea, frequent micturition, menstrual disorders, impotence, consumptive thirst, difficulty in flexion of hip joints, cold weak lower limbs, calf pain triggered by knee flexion, sciatica, epilepsy, hemorrhoid, malaria, eye diseases, yellowish sclera, blurring of vision, tinnitus, running nose, epistaxis, etc.

The Bladder Meridian of Foot Taiyang can be stimulated by stretching the posterior sinews of the lower limbs and, thus, tensing the associated muscles to relieve the above-mentioned symptoms. However, stretching the posterior sinews of the lower limbs is not easy, for it is hard for a person to raise his or her toes upward while keeping his or her body upright and maintaining balance.

It is therefore a need in a device allowing a user to stretch the posterior sinews of the lower limbs with a proper, stable posture.

### BRIEF SUMMARY OF THE INVENTION

The present invention solves this need and other problems in the field of stretching devices by providing, in a preferred form, a device for regulating Bladder Meridian and Channel Sinews of Foot Taiyang including a board having a top face and a bottom face. A rib is formed on an end of the top face. A plurality of holes are defined in the bottom faces and have different distances to the rib. A leg is removably engaged with one of the holes of the bottom face of the board to support the board in one of a plurality of inclination angles. In use, a user stands on the top face of the board, with his or her heels abutting against and supported by the rib. The feet of the user rest on the top face of the board and are, thus, in a bent position toward the lower limbs of the user to stretch the posterior sinews of the lower limbs of the user.

The present invention will become clearer in light of the following detailed description of an illustrative embodiment of this invention described in connection with the drawings.

### DESCRIPTION OF THE DRAWINGS

The illustrative embodiment may best be described by reference to the accompanying drawings where:

FIG. 1 shows a diagrammatic perspective view of a device for regulating Bladder Meridian and Channel Sinews of Foot Taiyang according to the preferred teachings of the present invention.

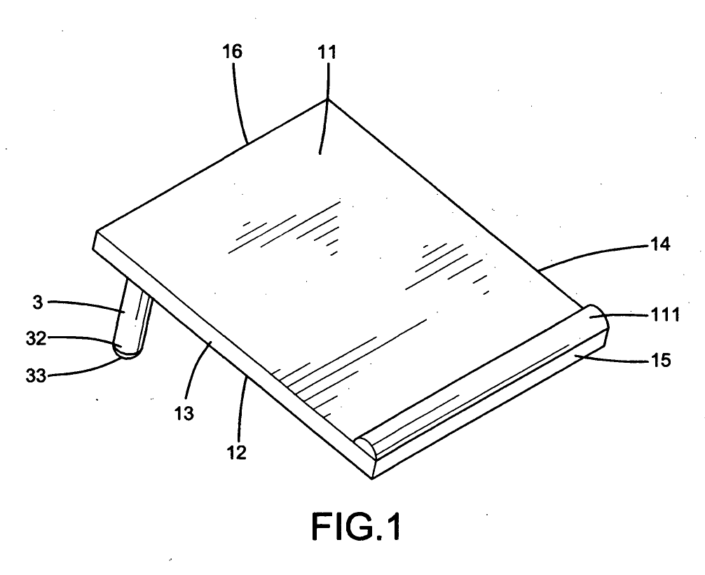

FIG. 2 shows an exploded perspective view of the device for regulating Bladder Meridian and Channel Sinews of Foot Taiyang of FIG. 1.

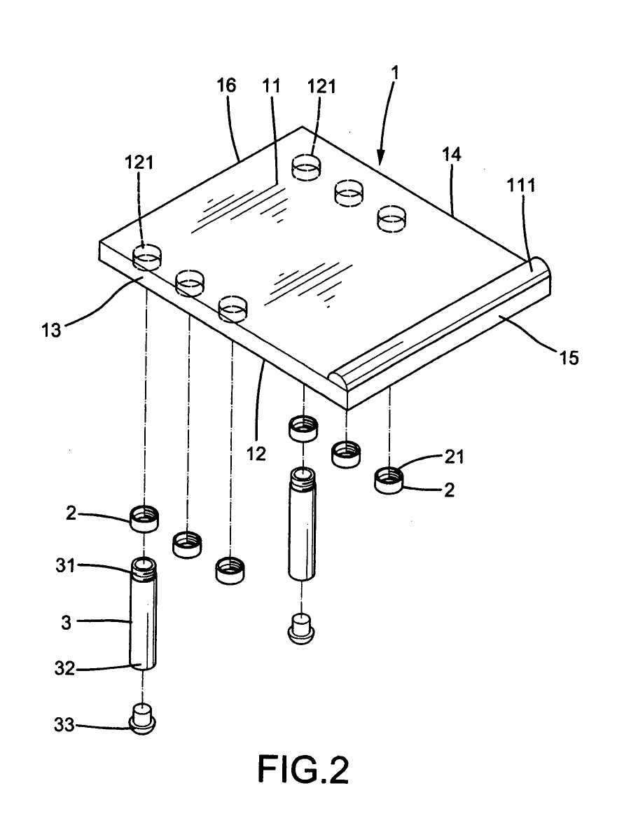

FIG. 3 shows a cross sectional view of the device for regulating Bladder Meridian and Channel Sinews of Foot Taiyang of FIG. 1 with a board of the device at a smaller inclination angle.

FIG. 4 shows a cross sectional view of the device for regulating Bladder Meridian and Channel Sinews of Foot Taiyang of FIG. 1 with the board of the device at a larger inclination angle.

FIG. 5 is a schematic side view illustrating use of the device for regulating Bladder Meridian and Channel Sinews of Foot Taiyang of FIG. 1.

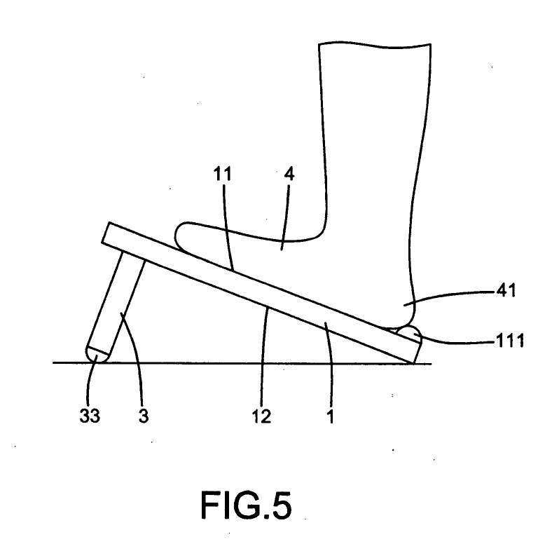

All figures are drawn for ease of explanation of the basic teachings of the present invention only; the extensions of the Figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms ‘lower’, ‘upper’, ‘top’, ‘bottom’, ‘front’, ‘rear’, ‘end’, ‘lateral’, ‘distance’, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

A device for regulating Bladder Meridian and Channel Sinews of Foot Taiyang according to the preferred teachings of the present invention is shown in the drawings and generally utilized for stretching the posterior sinews of the lower limbs of a user. The device for regulating Bladder Meridian and Channel Sinews of Foot Taiyang according to the preferred teachings of the present invention includes a board 1 including two lateral sides 13 and 14 and top and bottom faces 11 and 12 extending between the lateral sides 13 and 14. A rib 111 is formed on a front end 15 of the top face 11 of the board 1. In the preferred form shown, the rib 111 includes arc-shaped cross sections and extends between the lateral sides 13 and 14 of the top side 11. The rib 111 may be fixed to the top face 11 by glue, nails, screws, etc. Defined in the bottom face 12 are a plurality of holes 121 that are spaced from each other and that have different distances to the rib 111. In the most preferred form shown, the holes 121 are arranged in two rows extending from a rear end 16 of the board 1 toward the front end 15 of the board 1, with each row of holes 121 having regular intervals therebetween. Each hole 121 receives a coupling ring 2 having an inner threading 21. The coupling rings 2 may be fixed in the holes 121 by tight fitting or other suitable methods.

A plurality of legs 3 are mounted to the bottom face 12 of the board 1 to support the board 1 in an inclined position at an acute angle with a surface such as the ground or a floor surface, with the front end of the 15 of the board 1 on the surface. In the most preferred form shown, each leg 3 includes an upper end 31 with outer threading for coupling with the inner threading 21 of one of the coupling rings 2. Each leg 3 further includes a lower end 32 to which a pad 33 is mounted. The pads 33 are made of a material having a high frictional coefficient such as rubber to avoid undesired sliding of the board 1.

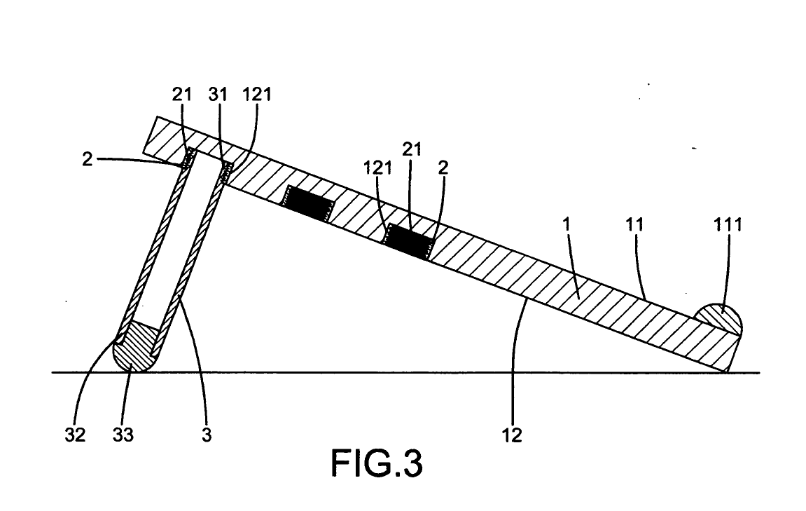

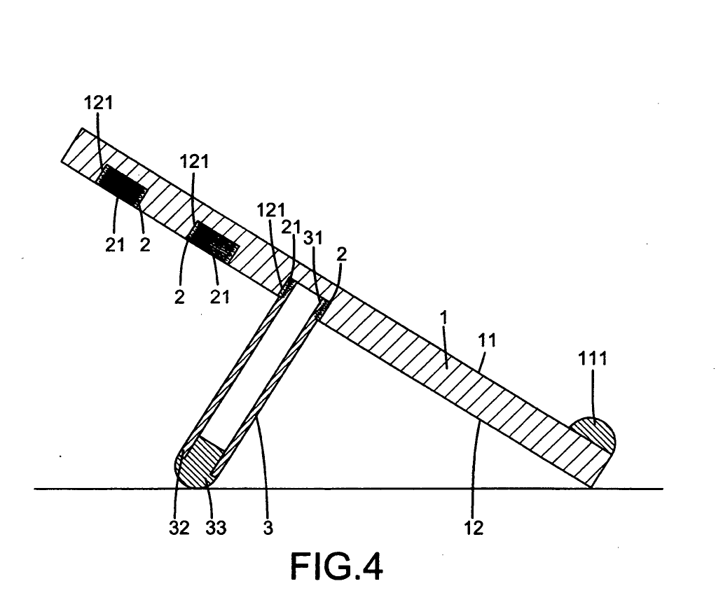

The position of the legs 3 can be adjusted by selectively engaging with the holes 121 of different distances to the rib 111, as shown in FIGS. 3 and 4. Thus, the inclination angle of the board 1 or the acute angle between the board 1 and the surface can be adjusted according to need.

In use, the user places his or her feet 4 onto the top face 11 of the board 1, with the heels abutting against the rib 111, with the body balanced and upright, with the belly slightly drawn inward, with the chin retracted, and with the vertebra straight and slack. In this posture, the feet 4 of the user are in a bent position toward the legs of the user. Thus, the posterior sinews of the lower limbs of the user are stretched. Stimuli, such as muscular contraction and relaxation, variation of tension, heat generated by muscular contraction, and chemical stimuli arising from metabolites of muscular contraction (for example, lactic acid, carbon dioxide, and transmitter), activate Bladder Meridian of Foot Taiyang afterward, with vital energy being transferred along meridians and channels. The ‘conveying vital energy and blood, coordinating yin and yang’ function of meridians and channels, the coordination of the internal organs of the body, and the body's immunity are enhanced, which is conducive to health and longevity. It is noted that the users feet 4 are supported by the rib 111 while stretching his or her posterior sinews of the lower limbs, assisting in maintaining balance of the user's body as well as keeping the proper posture for stretching the posterior sinews of the lower limbs. The rib 111 having arc-shaped cross sections avoids pain in the calcaneus of each heel of the user by preventing the calcaneus from being pressed by the rib 111.

The number of the holes 121 and the legs 3 can be varied according to need. As an example, the bottom face 12 of the board 1 may include only one row of holes 121. Furthermore, the locations of the rib 111 and the holes 121 and the distances of the holes 121 to the rib 111 can be varied according to need. Further, the legs 3 may have other shapes including but not limited to inverted T-shape such that a single leg 3 is sufficient to stably support the board 1 in an inclination to the surface. Further, the pads 33 can be omitted.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A device for regulating Bladder Meridian and Channel Sinews of Foot Taiyang comprising:
a board including a top face and a bottom face, with a rib being formed on an end of the top face, and with a plurality of holes being defined in the bottom faces and having different distances to the rib; and
a leg removably engaged with one of the holes of the bottom face of the board to support the board in one of a plurality of inclination angles,
with the rib being adapted to abut against and support heels of feet of a user standing on the top face of the board, with the feet of the user resting on the top face of the board and, thus, in a bent position toward lower limbs of the user to stretch Achilles tendons of the user.

2. The device for regulating Bladder Meridian and Channel Sinews of Foot Taiyang as claimed in claim 1, with the leg including an upper end and a lower end, with the upper end of the leg including an outer threading, with the Achilles tendon stretching device further comprising, in combination: a plurality of coupling rings respectively engaged in the holes of the bottom face of the board, with each of the coupling rings having an inner threading for releasably coupling with the outer threading of the upper end of the leg.

3. The device for regulating Bladder Meridian and Channel Sinews of Foot Taiyang as claimed in claim 2, with the second end of the leg further including a pad mounted thereto.

4. The device for regulating Bladder Meridian and Channel Sinews of Foot Taiyang as claimed in claim 1, with the rib including arc-shaped cross sections.
